(19) United States
(12) Patent Application Publication
(10) Pub. No.: US 2008/0002776 A1
(43) Pub. Date: Jan. 3, 2008

(54) Media Content and Enhancement Data Delivery

(75) Inventors: Timothy Borer, Surrey (GB); Joseph Lord, Middlesex (GB); Graham Thomas, East Essex (GB); Peter Brightwell, London (GB); Philip Nicholas Tudor, Surrey (GB); Andrew Cotton, London (GB)

Correspondence Address: FISH & RICHARDSON PC, P.O. BOX 1022, MINNEAPOLIS, MN, 55440-1022, US

(73) Assignee: BRITISH BROADCASTING CORPORATION (BBC), London (GB)

(21) Appl. No.: 11/568,488

(22) PCT Filed: Apr. 30, 2004
(86) PCT No.: PCT/GB04/01878

§ 371 Date: Mar. 15, 2007

(51) Int. Cl. H04N 7/12

(52) U.S. Cl. 375/240.26

(57) ABSTRACT

A method of outputting media content is described. The media content is coded according to a predefined coding scheme to produce coded media content. Enhancement data, comprising information for selectively enhancing at least one portion of the media content, is also supplied. A corresponding method of providing media content is also described, including receiving enhancement data for selectively enhancing at least one portion of the media content and providing enhanced decoded media content for the at least one portion based on the enhancement data. By providing selective enhancements, e.g. of critical portions, a user experience can be improved without requiring a significant increase in bandwidth and enhancements may be delivered over a different channel to the basic data.

The present invention relates to the delivery of media content, particularly, but not exclusively, compressed media content.

Media content, for example video and/or audio programmes are in many cases transmitted as compressed digital data, for example using MPEG-2 or a similar compression system. The compression systems used are typically not lossless; some information is lost in the coding process, the process being arranged to minimise the perceptible effect of the loss of information and make efficient use of available bandwidth. The bandwidth required and the quality can be adjusted by choice of coding parameters, the quality generally being reduced as bandwidth is reduced. Generally the coding parameters are chosen automatically for a given bandwidth but in some cases for non real-time compression (e.g. producing a DVD recording), a slight improvement in quality within a given bandwidth may be possible by finely adjusting the coding decisions. However, in general with a given type of source material and coding system, there is a generally accepted relationship between quality and bandwidth.

Improving quality and/or reducing bandwidth have been aims from the outset of digital media transmission. The conventional approach has focussed on improving the choice of coding decisions within a given coding scheme, proposing extensions which deal with limitations of coding schemes and on devising more efficient coding algorithms and there has been significant progress in these directions and the H264 coding scheme uses approximately half the bandwidth of MPEG-2 to achieve a similar quality. It is likely that further improvements in coding schemes will yield further improvements.

However, the present invention takes a different approach.

According to a first aspect, the invention provides a method of outputting media content comprising coding the media content according to a predefined coding scheme to produce coded media content, characterised by supplying enhancement data comprising information for selectively enhancing at least one portion of the media content.

Thus, according to the invention, it has been proposed that for a given coding scheme, the apparent quality achieved from a given media transmission system arranged for transmission at a particular bandwidth can be significantly enhanced by selectively enhancing one or more critical portions of the content. Thus rather than increasing overall bandwidth, pursuant to the invention it has been appreciated that selected portions of the content may be “intelligently” enhanced, for example to enhance portions of particular interest (for example a critical decision in a sporting event) or to improve portions which are less well coded by the basic coding scheme (for example a particular visual effect or rapid movement etc).

The predetermined coding scheme is preferably a recognised standard coding scheme, for example MPEG-2 or AVC etc so that a standard decoder receiving the standard output can decode the content without using the enhancement without modification. However, a modified decoder may incorporate the enhancement to produce enhanced output. Although the predetermined coding scheme may be a compression encoding scheme, this need not be the case and the predetermined coding scheme may e.g. comprise an analogue coding scheme.

Thus, in a complimentary second aspect, the invention provides a method of providing media content comprising receiving media content coded according to a predefined coding scheme and decoding the media content to produce decoded media content, characterised by receiving enhancement data comprising information for selectively enhancing at least one portion of the media content and providing enhanced decoded media content for said at least one portion based on the enhancement data.

The enhancement data will often be transmitted at a different time and/or by a different medium to the (basic) coded data. By way of non-limiting example, the standard coded data may be broadcast over a digital broadcast link (e.g. terrestrial, cable, satellite) or stored on a digital medium (e.g. DVD) and the enhancement may be made available for download over a communication link, such as the Internet or by dial-up or may be broadcast in separate bandwidth.

Typically the enhancement data will be made available subsequent to the coded data as it may require some time to select portions to enhance. However, the data may be available in near-real time, for example a few seconds or minutes after the basic data. In one embodiment, the enhancement data are generated based on selection input signifying a portion of the content to enhance. In response to the selection input, an enhancement generator may be arranged to compare the output coded data to the input data and to generate enhancement data comprising difference information for enhancing the decoded data.

The selection input may be generated manually, for example by a user viewing the data and, for example, signalling that a particular portion is of interest, for example in a sporting event. Additionally or alternatively, the selection input may be generated automatically, for example by a difference detector detecting errors in the original coding above a threshold or applying an algorithm to detect errors which are expected to be particularly noticeable or detecting events (e.g. a crowd cheer in accompanying audio) indicative of portions likely to be of particular interest.

Although the enhancement data will typically be created by an editor or content author, it is possible for enhancement data to be generated on request, interactively. For example enhancement data may be generated for a portion of media content following a request by a user. A receiver may include means for signalling to a server a portion of content of interest to a user (for example based on user viewing or positive input from a user) and the server may process inputs from individual users, optionally on payment or authorisation, or from multiple users and control generation of custom enhancements in response to demand.

Although the invention is particularly applicable to media including compressed video digitally stored, it may be applied to audio data. It may also be applied to data which has not been “compressed” in the conventional sense but wherein the original coding or transmission format permits enhancement; for example with conventional PAL video signals it would be possible to enhance the quality by transmitting enhancement data to mitigate PAL coding artefacts.

Further aspects and preferred features are set out below. All method aspects and features may be provided as apparatus aspects or features or as computer programs or computer program products and vice versa. Features may be provided in alternative combinations.

An embodiment will now be described by way of example, with reference to the accompanying drawings in which:

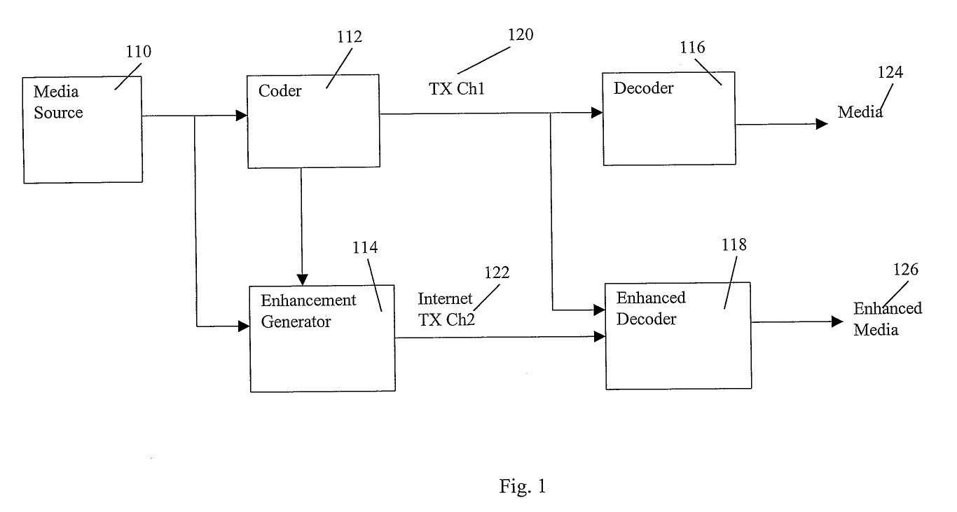

FIG. 1 is an overview of a system embodying the invention; and

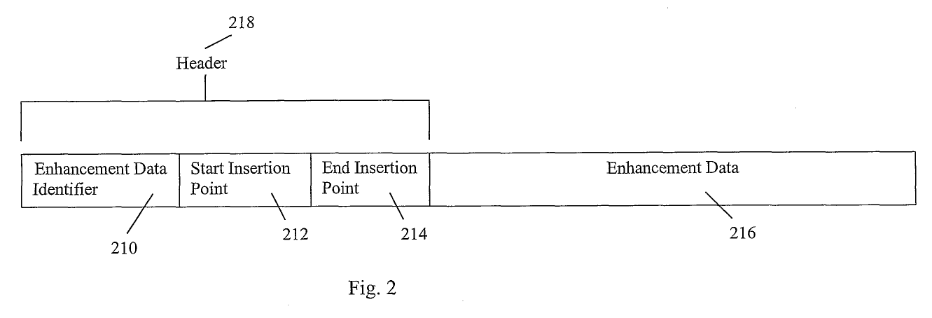

FIG. 2 is a schematic view of an enhancement data package.

The embodiment is concerned with the enhancement of compressed media content. In the context of modifications to compressed media content it can provide a novel, flexible and efficient approach to the distribution of programmes via multi-media channels.

Because the concept represents a somewhat radical approach to media content delivery, some background information is first presented below explaining the underlying inventive concept and potential advantages of implementation of the novel delivery methods and applications it provides before detailed implementation description.

### BACKGROUND

One advantage of media enhancement is the ability to combine content from different sources, delivered via different, diverse media, in a unified, efficient and flexible manner. Enhancement provides a method of improving the quality of broadcast audio and video after they have been received and stored. It is well suited to an environment of converged broadcast and internet infrastructure in which personal video recorders (PVR)s are common. Essentially, enhancement involves replacing parts of a pre-existing programme, which might be stored on a PVR. The enhancement might be delivered by any media including the internet, pre-recorded content (e.g. digital versatile disks (DVDs)) or broadcast channels. The receiver may then replay content that has been enhanced by integrating the pre-existing programme and the enhancement.

Broadcasting and the entertainments industry are in a period of rapid technological change. Hitherto the delivery of programmes and information via radio, television, recorded media, the internet, and personal computer technology have been largely independent. The embodiment helps the delivery media to converge to provide unified services and delivery mechanisms. Broadcast delivery may become increasingly, but not exclusively, non-real time with the increasing uptake of “personal video recorders” (hereafter digital video recorders). That is, users may access information, listen to and view programmes at their convenience, rather than when the service providers deliver them. It has been appreciated that this provides an opportunity to enhance the content.

The embodiment provides the enhancement of media content which provides a new mechanism for the delivery of content via a multiplicity of media channels.

The concept relates to a method for improving the quality of broadcast audio and video after they have been received and stored. The bandwidth available for programme delivery is limited. Consequently some users may desire higher quality or additional content or features. These can be delivered, in the form of enhancements, after the original content has been broadcast. With the increasing use of digital video recorders (or DVRs) and similar devices enhancements may well be applied after broadcast, but effectively invisibly, before the user has seen or heard the content. Enhancement is particularly suited to use with DVR like devices but in some cases can be used essentially “on-the-fly” with more limited buffering.

Essentially enhancement involves replacing parts of a pre-existing programme. The enhancement data might be delivered by any media including the internet, pre-recorded content (e.g. DVDs) or broadcast media. In particular the enhancements might well be delivered either before or after the broadcast. In order to implement enhancement the embodiment provides a system for locating the section of a programme to be replaced or modified by an enhancement, to provide the enhancement itself and a way of inserting or integrating the enhancement data with the original content to produce a playable programme. It has been appreciated pursuant to the invention that techniques used to incorporate repair patches in the field of software program debugging are well suited to this task and may be used, modified as appropriate, to incorporate enhancements in media content.

One important consideration is that, in many but not all cases, multiple different enhancements are possible for different purposes and these may be delivered by any available medium. A broadcast or unicast signal is taken as the basic content and this can be enhanced and modified in many ways by enhancement. Described herein is a system for ensuring that the content and appropriate patches are brought together prior to display or auditioning the content. Thus enhancement is an enabling technology facilitating the convergence of media delivery systems and technologies.

One embodiment of a system in which the methods described herein may be implemented is illustrated schematically in FIG. 1 which is an overview of a system.

Media content is made available, for example for broadcast onto a transmission system or for download, from a media source 110, for example a transmission server of a broadcasting company. The media content is preferably transferred to a coder 112, to encode the media content for transmission. The media data may be encoded using known coding techniques such as MPEG or AVC, as described in more detail herein.

The media content may also be transferred to an enhancement generator 114, which may generate enhanced portions of the media content based on the output of the coder and the original media source. As described in more detail herein, portions of the media content may be enhanced automatically or based on user input (not shown). Enhanced portions of media content may be stored and transmitted to users by a channel which may differ from the original transmission channel.

Media content from the coder 112 may be transmitted over a first transmission channel 120, TX Ch1, to a user. The first transmission channel may comprise, for example a broadcast channel or a transmission over a network, such as the Internet. The content may be transmitted to a decoder 116 associated with the user and the decoder 116 may generate media content 124 from the received signal.

Enhanced media content, generated by the enhancement generator 114, may be transmitted to another user automatically, or on request from the user. The enhanced media content may be transmitted over the first transmission channel 120, TX Ch1 but in this embodiment however the enhanced media content is transmitted over a second transmission channel 122, which may comprise another media broadcast channel or bandwidth in a transport stream, TX Ch2 or a network, such as the Internet. In an alternative embodiment, the enhanced media content may be delivered to the users via a separate system, such as on a DVD.

The enhanced media content is preferably transmitted to an enhanced decoder 118 and is decoded for viewing by the user as enhanced media content 126.

The structure of an item of enhancement data according to one embodiment is illustrated in FIG. 2. The enhancement data may comprise a header portion 218, which may contain metadata, such as an enhancement data identifier 210, a start insertion point 212 and an end insertion point 214. The enhancement data identifier 210 may comprise, for example, data to identify the media content to which the enhancement data relates as well as an identifier of the enhancement data itself.

The start and end insertion point data 212, 214 may include data identifying where the enhancement data should be incorporated into the media content, and may include context information, as described herein.

Other data, for example enhancement permission information, encoding information, information identifying the source of the media content or enhancement data or an indicator of the length of the enhancement data may be incorporated into the header and the enhancement may be encrypted.

The enhancement data itself 216 is preferably included after the header section 218, in compressed or uncompressed form.

Enhancement Overview

An enhancement is a piece of data or content that is used to replace a corresponding piece in a pre-existing programme. The enhancement could be used to mitigate a coding error or to introduce a new feature or improvement. An enhancement does not replace or enhance the whole of a programme but only affects part of the programme whilst leaving the remainder essentially unchanged. Multiple enhancements may in principle be applied to a programme and, sometimes, the set of these elemental enhancements may, itself, be referred to as an enhancement. Enhancements may be applied successively or cumulatively, or to independent portions, and it is in principle possible, for example, to enhance an enhancement.

In application to broadcast distribution, one useful model has the basic layer sent conventionally and other quality levels and services layered on top. By taking advantage of the high bandwidth and low cost of broadcast transmission additional services can be provided more flexibly and at lower cost.

The focus in this document is on enhancement of compressed media content. Compressed content has to be decoded prior to display. We have appreciated that the compressed signal might, therefore, be regarded as instructions for constructing the final signal rather than as the signal itself. Hence, one enhancement possibility is in modifying the instructions used to recreate the original content (i.e. in enhancing the coded content). However enhancement may also be generalised to include the replacement or upgrading of pieces of uncompressed content, for example by sending a difference between the uncoded content and the desired output, for example as a JPEG or other compressed difference image.

This document concentrates on audio and video content. The concept of enhancement is not restricted to these types of media but might equally well be applied, for example, to the 3 dimensional models used in an interactive application and to streams used in virtual reality applications.

There are several key features applicable to enhancement of media content. Enhancements only affect part of the signal; the remainder is unaffected and remains unchanged. Thus, enhancements provide generally discontinuous and discontiguous amendments to existing content.

However, in one possibility, the signal may be extensively enhanced, as a means of providing a novel coding scheme in which a highly enhanced low bandwidth basic coded signal together with multiple enhancements provides a user-perceptible quality better or equivalent to a higher bandwidth basic signal but requiring less aggregate bandwidth than the higher bandwidth signal; for example an X (e.g. 2) Mbit/s AVC or MPEG coded signal together with Y (e.g. 1) Mbit/s of enhancement data may provide a user experience better than an X+Y (e.g. 3) Mbit/s conventionally coded signal.

Enhancements are typically separate entities to the original content, which may be decoded without using them. This means that enhancements may be transmitted to the user by any available medium. They may arrive before or after the main content and be delivered more slowly or faster than real time.

The process of digital compression often involves the loss of fidelity. This is known as lossy encoding. For digital broadcasting the quality of the signal is reduced during the compression process before it is broadcast. Ideally the quality received should be identical to the original, uncompressed, signal. The reduction in fidelity due to compression of the signal is not constant. The compression process for broadcasting is usually required to produce a (roughly) constant data rate, but the complexity of the signal varies. So the “damage” done by the compression process varies.

Enhancement may be viewed as system for improving the quality of broadcast signal after they have been broadcast. This is achieved by supplying additional or replacement data for the sections that have been most impaired by the compression process and/or sections which are most of interest to a viewer or where the impairment is most noticeable. Content enhancement is not, in itself, a compression system but as mentioned above can be used to provide a novel derivative compression system. Rather it provides a technique that can be used to improve the performance of other compression or transmission systems. It is important to note that enhancement is directed to correcting or improving the basic broadcast signal rather than dealing with errors in transmission.

In order to implement a practical enhancement system several elements are desirable. One element is means to determine the parts of the signal to be replaced. This may involve determining which parts of the signal were most impaired by the compression process. However the parts of the programme for which enhancements could be generated could also be based on quality, editorial choice or some other criteria. A means of encoding and transmitting the enhancement data to improve these sections of the signal to the user is another element. A further element is a means to integrate this improved data with the original data so that it can be presented to the user. These elements may each be implemented in a variety of ways and are essentially independent so may be combined in a number of combinations; in some cases only certain novel components are required, the remainder using existing elements. Each of these elements will be considered in more detail below.

Enhancement provides a highly flexible way of delivering content using aggregated bandwidth on multiple media. For example the basic signal could be acquired over normal broadcast channels. Enhancements placed on a web server can provide additional quality. A DVD could be used additionally or alternatively to provide enhancements. In the latter case a DVD might be provided to subscribers of a premium service or might be provided as a “cover disk” on the cover of a magazine such as a programme listing guide. A single piece of content can have multiple enhancements referring to different parts of the signal and these enhancements could come from the same or different providers. Enhancement allows efficient use of broadcast signals whilst also permitting the provision of more niche services by multiple providers.

There are some superficial similarities between enhancement and other transmission and compression techniques, but these are merely superficial. To ease understanding, below we seek to highlight the differences between the use of enhancement and conventional techniques.

One important distinction is between enhancement and the retransmission of erroneous data. To illustrate the point consider the example of multicast distribution via the internet. When content is distributed via the internet using multicast technology the content is typically sent using UDP, a well known, but unreliable, data transfer protocol based on IP (Internet Protocol). Because the transmission protocol is unreliable receivers may contact the server and request retransmission of parts of the content that were not correctly received. This is different to enhancement for several reasons. Corrections are needed because of errors in the transmission process rather than limitations of the compression process and the end result is merely a correct version of the same content, rather than an enhanced quality version. Corrections are re-sent soon after transmission using the same transmission medium (the network) whereas this need not apply to enhancements. Corrections are simply repetitions of data that has already been sent, not amendments to it. Indeed the well-known TCP protocol implicitly includes this basic retransmission of missing data. Enhancement is, fundamentally, different from retransmission because the need for retransmission is occasioned by errors in the transmission process rather than limitations in the compression coding.

A feature of enhancement a compressed signal, in contrast to repeated data to repair transmission errors, is that it will generally alter the length of the compressed signal. In many applications the patch would be applied in order to improve the quality of selected portions of the basic content. In this case a portion of the encoded (i.e. compressed) basic content would be replaced by a larger portion of upgraded content.

There is considerable prior art for content compression in which content is sent as more than one stream. Hereafter these may, collectively, be referred to as multistream coding. Superficially these schemes have similarities to enhancement, however there are also fundamental differences.

It is worth briefly reviewing multistream coding before discussing how it differs from enhancement. Typically multistream coding schemes have a base layer and one or more additional layers. The base layer can be coded on its own or it can be decoded in conjunction with the additional layer to produce a higher quality image. These schemes include:

Stereo Coding The classic multistream coding technique is mono and difference signals used for coding stereo signals. A listenable signal is provided by the mono signal alone. A stereo signal is generated if both the mono and the difference signal are decoded together.

SNR Scalability: Signal to Noise ratio scalability (standardised for MPEG 2 video compression). The base stream contains coarsely quantised samples. The additional layer contains a difference signal that is more finely quantised. Decoding both layers together provides an improved signal to noise ratio compared to decoding the base layer alone.

Spatial Scalability This might also be called “Resolution Scalability” but Spatial Scalability is the accepted term (also MPEG 2). The base layer contains a low resolution signal (derived by filtering and subsampling a higher resolution signal). The decoded low resolution signal could be upconverted to a sampling lattice that supports a higher resolution. The difference between the upconverted base layer and the original higher resolution image is coded as an additional layer. Decoding both layers together provides a higher resolution image than decoding the base layer alone.

Frequency Scalability This is similar to spatial scalability in that it provides a low resolution base layer and a higher resolution signal when combined with the enhancement layer. However it is implemented differently. In this case the high resolution image is coded directly (rather than being down converted and coded as a low resolution image as in Spatial Scalability). But, only the low frequency components are coded in the lower layer. This could be achieved by low pass filtering the signal before coding. Most compression schemes involve a transform that approximately converts the signal to the frequency domain. So the base layer, in a frequency scalability system, can simply encode the low frequency transform coefficients (and ignore the high frequency ones). The high frequency components are coded in the additional layer.

Hierarchical coding: Typically used for still image compression on the internet. A low resolution signal is transmitted first, followed by successive information to produce successively higher resolution images. In this way the user sees the overall structure of the image first but the detail takes a while to build up. This is similar to Spatial Scalability.

Pyramid coding: This is a multi-layer scheme whereby images are coded as successively higher resolution images in a “multi-resolution pyramid”.

Multiple description coding: Multiple description coding is intended for environments with multiple, but unreliable, channels, such as the internet. Two or more “descriptions” are transmitted. Either on its own would give a representation of the signal. However the best signal would be obtained by combining two or more “descriptions”. The advantage is that if one description is completely lost the user still gets a signal.

Embedded coding (particularly used with wavelet coding): Embedded coding is used for still image coding. The image is coded in such a way that by receiving the whole coded stream the original image is regenerated without loss. The coded stream can be truncated at any point to provide a degraded image.

The key difference over conventional multiple stream systems is that conventional multiple streams are generated for the whole duration of the signal rather than enhancement data being selectively generated. The multiple streams are generated at the same time. They are sent over the same medium, although they may occupy different channels. For example broadcasting HDTV might send a base layer signal, which could be decoded as standard definition TV, via one channel and a HDTV enhancement layer via a different channel. However, both channels use the same medium (TV broadcast channels). Similarly multiple description coding might use multiple internet routes, but the medium in both cases is the same, i.e. the Internet. It would not be possible to take a multistream coder and, use it to create an enhancement.

The typical sequence of generating the compressed signal and enhancement data also differs from that of generating multistream signals. Multistream components are generated more or less simultaneously. Enhancement data are always created after the original compressed stream has been coded (although (a) it may be distributed first, and (b) it may be automatically generated close in time to the coding). Enhancement data could conceivably be created, by different suppliers and for different purposes, long after the original coded signal was created.

Enhancement as described herein allows the enhancement data to be acquired at a different time from the main signal and/or via a different route. One possibility is to for a content provider, who has a presence both as a broadcaster and on the Internet, to broadcast a basic signal containing content and place enhancement data on a web site. The basic signal could be a standard television or radio programme. The enhancement data could be generated after the programme had been created or broadcast. The user could, at a later time, download an enhancement to a program captured on a video or audio recorder. Ideally the signal would be recorded in the original compressed format in which it was broadcast, but this is not essential (see below). Alternatively enhancement data could be made available before transmission so that an improved quality rendition of the programme could be achieved almost immediately after it had been broadcast.

Enhancement can be applied to compression systems that do not themselves intrinsically support hierarchical or scalable coding. For example many applications use MPEG 2, main profile, which does not support scalable coding. Nevertheless, by enhancement, using MPEG 2, main profile, files, some of the advantages of scalable or hierarchical coding can be gained without modifications to the (standard) decoder.

Another feature of enhancement that distinguishes it from hierarchical or other multistream techniques is that the same decoder may be used for decoding both basic and enhanced content. Often with multistream compression systems a simple decoder can decode basic content from one of the streams. However a special decoder is usually required to extract improved quality from multiple streams. With enhancement, by contrast, the enhanced stream may simply be a different instance of a compressed stream and so the same decoder can be used for enhanced content as for the basic content. In practice, the decoder will typically need to cope with a higher bit rate for the enhanced stream than the basic stream.

Another advantage of enhancement is its ability to combine content from different sources, delivered via different media, in a unified, efficient and flexible manner. The applications described below illustrate different aspects of these underlying properties of enhancement.

Restoring Compression Losses

A basic use of enhancement is to restore the losses introduced by the compression process. This can be considered analogous to a bug correction patch in software. Many types of content require live broadcast, for example new, sport and live events. This requires real-time coding of the content, which restricts coding efficiency. After a programme has been transmitted enhancement data (akin to software patches) can be generated for those parts of the programme that have been particularly impaired by compression. These enhancement data could, for example, be made available on a web site or be transmitted as auxiliary data in the broadcast data stream. Such enhancement data could be more highly compressed, e.g. by taking advantage of more computationally intensive or multipass techniques. Enhancement data could be generated and incorporated by the replay device for higher quality presentation at a later time. This technique fits well into the context of converged broadcast and internet services and PVR/DVR technology.

Enhancement provides a means of combining the immediacy of real time coding with the coding efficiency of non-real time techniques. Enhancement data could be provided to improve the quality of important parts of the content. For example, the quality of the image of the moment when a goal is scored in a football match might be a particular part of the content that was worth improving. Similarly a disputed line call in a tennis match might benefit from enhancement to provide the highest quality image. Since not all the content has to be enhanced in this way both processing power and delivery bandwidth can be used in an optimum way to enhance the quality of just those parts of the content that are particularly important.

A characteristic of enhancement is that the enhanced content cannot be viewed truly “live” thus it is primarily applicable to parts of the content that would be replayed, such as “action replays” in sports programmes although a small delay (of the order of seconds in some cases) may be sufficient to enable near-live use of enhanced content. By making enhancement data available quickly after transmission a near instantaneous replay would be possible.

Extending the Original Programme

Enhancement can go further than simply correcting the losses introduced by the compression system. Enhancements can be provided to the original programme material. This is analogous to an “upgrade” for software. The section provides a few examples of such enhancement processes.

Aspect Ratio Enhancement

One possible enhancement to a video signal would be to add extra material to convert a standard 4:3 aspect ratio video sequence to widescreen (e.g. aspect ratio 16:9). The enhancement data in this case provides additional material to be added to the edges of the conventional image to produce a widescreen image.

In this application the “side panels” that are “patched” onto the basic content can be in lower resolution than the information at the centre of the screen. In this way the bandwidth required for distribution of the enhancement data can be reduced. If there was a sudden reduction in resolution at the transition between basic content and the enhanced content the join might be visible. To avoid this, the resolution can be reduced gradually away from the transition point. Gradual resolution changes of this type can be achieved by applying a spatially varying filter to the original content so that the resolution reduces gradually away from the central part of the picture (the central 4:3 part of the picture representing the basic content). The side panels can be separated from the filtered (widescreen) image and compressed and packaged to form an enhancement. Most compression systems will take advantage of the gradual reduction of resolution to towards the edge of the picture and produce an enhancement with fewer bits as a result.

Resolution Enhancement

Many television pictures are already broadcast as “widescreen” in a “letterbox” format (with black stripes above and below the picture). In this case the appropriate enhancement would be to increase the spatial resolution.

For much of the duration of the programme it may be sufficient simply to upconvert the image to the higher resolution. This would be possible in the parts of the programme that do not exercise the full spectrum permitted by the sampling lattice. However, in some portions of the programme the loss of resolution due to simply upconverting would be noticeable. For these parts of the programme enhancement data could be applied to provide the additional resolution. Since additional processing must be applied to achieve this, the enhancement would usually be applied after decoding the basic content (see below).

The difference between resolution enhancement in this manner and layered, multistream, approach is that the enhancement data would only be applied to those parts of the programme that would particularly benefit from enhanced resolution (i.e. selectively). As with enhancement for widescreen, a lower spatial resolution may be acceptable at the edge of the picture compared to the centre and this would reduce the bandwidth required for enhancement.

HDTV

The process of resolution enhancement could be extended to enhancement to produce HDTV. Here again additional resolution could be provided for part of the programme beyond that provide by simply upconverting the basic transmitted image. HDTV enhancement data could be provided which enhanced the data directly from a standard definition image. Alternatively a second level of enhancement could be provided to upgrade an enhanced resolution image.

Multichannel Audio

Audio quality can also be improved by the use of enhancement. For example, the basic content might comprise a standard stereo pair. An additional centre channel might be provided as an enhancement. A centre channel might only comprise low frequency information, in which case it would require only a small data capacity to transmit an enhancement. As with other enhancement techniques described herein, enhancement data do not have to, and typically would not, patch the entire duration of the content. In the case of enhancement audio in this way extra information might only be provided for those parts of the content where it was dramatically significant. For other parts of the basic content a centre channel could be derived from the stereo pair in well-known ways. It is likely, in this scenario, that that enhancement would be applied after decoding. The number of bits to create an enhancement for a centre cannel would be reduced because it is only the additional information, beyond that which can be deduced from the stereo pair, needs to be included in the enhancement data.

In addition to providing an extra centre channel audio signals can be enhanced, in a similar way, by enhancing them to provide additional “surround sound” signals. In this case, to achieve the correct subjective effect, it is likely that a basic stereo pair would have to be processed and combined with additional information from the enhancement data (for example by matrixing). To achieve this the enhancement data would have to be applied after decoding. Again, as for the addition of a central channel the enhancement only needs to contain information beyond that which can be derived from processing the information transmitted as basic content (i.e. the stereo pair). This reduces the number of bits that must be provided in an enhancement.

Enhanced Features and Access

Enhancement can provide additional features and enhanced access to programmes. Typically these sorts of features, including subtitles or signing for the deaf, or audio description for the visually impaired, are provided by additional programme channels or metadata. Often such features are only required by a small proportion of users, that is they are niche services. Because only a small proportion of end users require them these signals can occupy a disproportionate amount of the available transmission bandwidth. Enhancement provides a means of transporting this information to the end users who require it via a different medium, thus releasing bandwidth that can be used to improve quality for everyone else.

An enhancement provides a unified mechanism for providing additional features. Typically additional features have their own part of the bitstream. To use these features the bitstream has to be specified to include them and the decoder needs to know what to do with the additional information. This makes varying these features or adding new ones very difficult. Each type of (minority) user would then require a different type of media player to integrate their particular type of additional data with the basic content. If a decoder is designed to use median enhancements it can provide these additional services in a unified and flexible way. It doesn't matter to the decoder whether the enhancement data contains subtitles or a signing image, it can deal with them both in the same way. By using enhancement these development needs can be amortised over the whole population, including the majority population, who also require enhancement for reasons discussed elsewhere.

For signing a small image of a signer (or just their key attributes) might replace part of the main image to convey spoken content. This would be similar to inserting a logo. The position of the signer would be specified in the enhancement data and so could vary with the scene content. Alternatively the image of a signer could be added to the side of an image leaving the main action unimpaired. This is similar to enhancement 4:3 aspect ratio images to convert them to wide screen.

Another use of enhancement is the provision of multilingual subtitles. In a multi-cultural world there is not always sufficient bandwidth to provide subtitles in all the languages that are spoken. By providing subtitles as enhancement data a large number of languages can be addressed without the need to broadcast large amounts of information only needed by a minority audience. Again these could replace part of the main image or be provided as additional picture below or to the side of the main image.

In the case of, for example, the provision of subtitles for the deaf it would be beneficial if enhancement data could be transmitted before the main (presumably) broadcast content. Sometimes this is not possible, e.g. for a live transmission. For live transmissions broadcasters sometimes use speech recognition to provide live subtitles. Unfortunately speech recognition systems unavoidably produce errors. If a viewer is able to wait to see a programme, or wishes to see a repeat, an enhancement could be used to provide correct subtitling. The delay in providing an enhancement gives time for subtitles to be checked and corrected by a human operator. As with other applications additional information may be provided by diverse media. So, for example, minority language subtitles might be distributed on magazines (e.g. programme guides) in those languages as “cover disks”.

Premium Services

Enhancement could be used for the delivery of premium content. For this application the enhancement data might be encrypted and could only be applied by authorised users (for example those who have paid an additional charge). For example a low resolution programme might be streamed over the Internet, and cached locally, the enhancement data could also be provided on a web site to improve the quality of the streamed programme once it had been delivered. In this case the same medium (i.e. the internet) is used for both the primary content and the enhancement data.

It is possible to apply multiple layers of enhancement to a single piece of basic content and thus achieve a hierarchy of quality levels. These could be used, for example, to provide a range of content quality depending on how much a user had paid, or alternatively may be used to tailor the content quality to the available distribution bandwidth. Of course this bandwidth can include contributions from a diverse range of distribution media.

Removing Logos and Adverts

Enhancement may be applied to remove either logos or adverts to convert free content to premium content. In the case of removing logos only part of the image is replaced. In the case of advert removal the enhancement would replace parts of the programme between an “in” time and an “out” time. Advert removal would require little bandwidth since it is primarily removing unwanted content. However, both for removing logos and adverts, some additional content would be required in the enhancement data to glue the parts of the programme together in a seamless way. Enhancement can provide more than simply the provision of “cut” edits.

Pre-Distribution

One use of enhancement would be to distribute enhancement data before the main content were transmitted. This might be advantageous for the distribution of premium content. Enhancements could be distributed to subscribers and combined, in real time, as the basic content is distributed. Enhancements could be distributed via a network (e.g internet or VPN). Alternatively enhancements might be pre-distributed on another medium such as CD or DVD. Another possibility is the distribution of enhancement data as part of a marketing initiative. Enhancements could be distributed via “cover disks” (e.g. CD or DVD) with magazines. In this case the content of the enhancements could be authored to reflect the mature of the magazine and the interests of its readers.

Editorial Changes

Enhancement can be used to customise basic versions of the content to provide specialist versions. For example a broadcast film might be enhanced to provide a “Director's Cut” version. Alternatively extra content might be added to cater to special interest groups as is done when programmes are released on DVD.

Future Proofing

The use of enhancement provides a measure of “future proofing”. Enhancement can use any compression algorithm, provided the enhancement is applied after decoding (see below). Hence, for example, the MPEG AVC coding algorithm, which is approximately twice as efficient as MPEG-2, could be used to enhance an MPEG-2 stream. This is significant because MPEG 2 is presently used for digital broadcasting. Because of the amount of equipment produced for digital broadcasting MPEG 2 cannot easily be replaced by a different compression algorithm. Similarly it is difficult to change the compression algorithm for basic content used by DAB (digital audio broadcasting, which uses MPEG layer 2 audio coding). However, more flexibility is possible in the choice of compression algorithms enhancements. If enhancements are applied by software it may be possible to upgrade the enhancement software. Alternatively a choice of enhancements can be made available based on different compression algorithms. By using improved compression algorithms enhancement can take advantage of advances in compression technology even when there is a large installed base of “legacy” equipment.

Implementation

Some more details of the implementation of enhancement systems are discussed in this section.

The principle of enhancement can be applied to any compression technique or, indeed, to uncompressed media content. The focus of this document has been on the enhancement of compressed streams and this will be discussed further below. The MPEG video compression system will be taken as an example of a compression system. The concepts of enhancement, exemplified with reference to MPEG, are applicable to other compression systems for both audio and video.

Different approaches to enhancement of MPEG compressed streams are possible depending on the size of the portion of the stream to be enhanced and the objective of performing enhancement. A simple implementation would simply replace whole GOPs (Group of Pictures or “access units” in other video compression systems or “frames” in audio compression systems such as MPEG Layer 2/3 audio.) within the compressed bit stream. An alternative would be simply to enhance I frames, that is replace the I frames whilst leaving the P & B frames (including motion vectors and mode decisions) the same. Another option would be to enhance transform coefficients for both I and P frames and leave B frames and mode decisions unchanged. Enhancement of parts of an image, for example to insert or remove a logo or advert, is more complex with MPEG. It is straightforward to replace the information (transform coefficients, motion vectors and mode decisions) for a part of an image. If the enhancement is, for example, a stationary logo this may actually reduce the bit rate since the motion is known, a priori, to be zero. Or the enhanced region might represent stationary, scrolling, or panning captions in which the motion is also known a priori. However, other parts of the GOP (other regions of the image on the same or other frames in the GOP) may also be changed and the system that generates the enhancement data must allow for this.

Enhancement can utilise idle processing capacity in DVRs (digital video recorders), or similar systems, to improve quality. In one scenario basic content would be captured on a hard disk or other storage medium to be replayed at a later time. The recording device may be connected via an always-on connection, such as an xDSL connection, to a network. If this is the case then the recording device can automatically search for, and apply enhancements to, the basic content that it has recorded, using processing capacity that would otherwise be wasted.

A selection of enhancements can be made available to users. Multiple enhancements, for the same enhanced content, could be provided. This would allow users to select an enhancement that matched their enhancement software, provided the best quality or required the least capacity to download.

Enhancement Before or After Decompressing

Enhancement can be applied either before or after the compressed signal has been decoded. Enhancement before decoding does not require a special decoder, but it does require the enhancement to be compressed using the same compression system. It may also complicate the process of integrating the enhancement to ensure that a legal compressed bit stream is generated and may alter the bit rate. Enhancements can also be applied after both the base content and the enhancement have been decoded. This is a more flexible arrangement. It allows the use of different compression systems for the base content and the enhancement. It also facilitates processing to combine the content and enhancement, such as might be required for enhanced resolution.

When enhancement is used prior to decompression the effectiveness of enhancement will vary with the compression system used. Considering MPEG as an example, the compressed data mainly comprises of three types of information: DCT coefficients, motion vectors and mode decisions. In principle enhancement can be used to replace any or all of this information for portions of the coded sequence. If complete GOPs were enhanced this is what would be done. But it is more flexible and potentially more efficient to replace parts of the GOP. It is straightforward to replace the coefficients for a frame without changing the motion vectors (although there are issues of drift, see below). However if the motion vectors are replaced it would be necessary to replace transform coefficients as well. Because of the side effects of replacing motion vectors content enhancement of MPEG signals would probably only replace transform coefficients. Hence improvements in coding efficiency are limited because only part of the coded information is replaced. However other compression systems generate motion vectors at the decoder from previously encoded signal (known as backward motion estimation as opposed to forward motion estimation used in MPEG coding). In these systems all the coded information may be replaced which may allow the effectiveness of enhancement in such systems to be greater than when used with MPEG.

If the content is enhanced after decoding then the compression algorithm used to compress the enhanced content can be completely different from that originally used to code the content. For example DTT is broadcast using MPEG2 but AVC (a.k.a. H264, MPEG 4 Annex 10) could be used to compress enhancement information. This is advantageous since AVC is about twice as efficient (i.e. same quality in half the bandwidth) and MPEG2.

To implement enhancement after decoding the basic decoded content and the decoded enhancement must be combined. The combination could be simply by replacement. Here parts of the basic content would be replaced by content from the enhancement data. Details of which parts of the content should be replaced are transmitted in the enhancement data in a similar way to what is done for software patches. Replacement can be a direct analogue of software enhancement. Alternatively the enhancement data may be combined in some other way, for example by adding the decoded enhancement data to the decoded base content. This option is novel and would apply only to enhancement media content and does not have a direct analogue in software enhancement.

The ability to use a different coder for enhancement data allows a broadcaster to take advantage of improvements in coding efficiency whist maintaining compatibility with an installed user base using older compression algorithms.

Selecting Content for Enhancement

To implement enhancement the parts of the programme to be enhanced must be decided. This decision can be based on compression impairments, temporal or spatial location in the programme or simply on the basis of editorial decisions.

The impairment of the programme can be determined by comparison with the uncompressed image. Distortion metrics such as MAD (mean absolute difference), RMS coding error, or entropy of the coding error can be used. The coding error may be processed, on the basis of psychoacoustic/visual criteria, prior to determining the distortion, so that the perceived quality is used to guide the selection of which parts to enhance. The parts of the programme with the highest local value of the distortion metric would be enhanced first, followed by parts of the programme with increasingly smaller distortion.

The need for enhancement to improve quality can be determined by the compression encoder. To do this the encoder needs to determine when the decoded picture quality falls below a certain threshold of acceptability. In the example of an MPEG video coder this could be done simply on the basis of the quantiser setting. If the quantiser step size was set to be larger than a threshold then that part of the content would be a candidate for enhancement. The priority for enhancement would depend on how much bigger the quantiser step size was than the threshold. Basic content coded with the largest quantiser step size would have enhancement data generated first. Enhancements could then be generated for portions of the basic content with progressively smaller quantiser step sizes. This could be continued until either all the (enhanced) content had reached the desired quality threshold or the maximum capacity available for transmission of the enhancements had been reached. All lossy compression systems use a quantiser somewhere in the algorithm. This technique, explained with reference to MPEG compression, can thus be applied to other compression systems.

Integrating Patches at the Receiver

Once the enhancement has been received it must be integrated with the original (compressed) content. Several ways of doing this are described below.

Time Code

In order to apply an enhancement the enhancement software must know to which part of the stream or file it should be applied. Many compression systems contain timing information but this is not always reliable. For example MPEG video streams often contain “timecode”. However the presence of time code is not mandatory in the MPEG bit stream and, even when it is available, timecode is notoriously unreliable. Nevertheless, when timing information is available in a compressed stream it can be used to provide a probable location for the enhancement to be applied.

Local Context

A more precise or other indication of the location to enhance may be required than is provided by timing information embedded in a compressed stream. By way of reference, for a software patch it is common to include the context surrounding the patch within the patch itself. This context can be matched against the original (compressed) context to determine the exact location to patch. Based on this principle, even if timing information in the compressed content is not sufficiently accurate to determine the precise location to enhance, it can still be used to find an approximate location. The enhancement encoder has access to the compressed basic content. Therefore the encoder can determine the amount of context that should be included in the enhancement data to provide a unique location for the enhancement. Alternatively a default size of context may be used, which is chosen to give an acceptable reliability in locating the position of the enhancement.

Feature Based Location

An alternative method of indicating a location for an enhancement in a video sequence might be provided by the use of a feature detector. A feature detector detects prominent features in the signal such as a picture cut in a video sequence. A cut detector analyses a continuous video sequence to determine the position of discontinuities, or cuts, between scenes. As one example, the enhancement data could contain information that it was to be applied n bytes after the m^{th} cut from the beginning of the sequence. The enhancement software could apply a specified cut detection algorithm to the basic content to locate the m^{th} cut. The advantage of this technique is that cut detection algorithms typically take little computing power. Hence it may be more efficient to look for cuts than to directly search for a sequence of bits in a compressed stream. It should be noted that the cut detector could be very simple because it is only required to produce the same result at the encoder and decoder, it does not have to be accurate. It does not matter if the cut detector falsely detects cuts or misses genuine cuts. Since the requirements are so modest a suitable cut detector could be implemented very efficiently. Extending the idea, any feature detector could be used in a similar manner to provide the location for enhancements in either audio or video content. Feature detectors could also be combined with searching for a known sequence of bits, the context of the enhancement, to locate the precise location to enhance.

“In Place Editing” Versus “Creating New Versions”

It is noted that in the case of software debugging, when a data file, such as source or executable software, is patched a new file is written. The new file may replace the file that is patched. This, simple, approach is an option for enhancement of content stored on a DVR. It may be quite applicable in the case where enhancements are applied “off line” when the DVR's processor would otherwise be idle. In this scenario multiple enhancements can be applied sequentially and a new enhanced file can be progressively constructed. Whilst the enhancement process is proceeding the original file, containing basic content, can still be accessed normally. Once enhancement is complete the new, enhanced, file may be renamed to replace the basic content. Alternatively the basic content may be retained so that a different set of, possibly incompatible, enhancements may be applied to produce different versions of the same basic content.

Media files may occupy large amounts of data storage. They are often big files. Therefore it may not always be practical to rewrite the file. It may be preferable to use a mechanism that modifies the basic content “in place”. Such a mechanism should preferably leave as much of the original file as possible unchanged whilst replacing the content to be enhanced in a transparent way. That is the enhanced file will contain much of the original content plus some new data but can still be accessed as easily as the original file.

Enhancement of large files of content “in place” may be achieved in several ways. One way is to break the stream into chunks and stored these in a linked list software structure. This may be done explicitly by the DVR when the content is originally stored. In this case the complete stream might be stored as a sequence of small files. The enhancement software, which applies enhancement data to the basic content, would have to know the format the data are stored in and be designed to work with it. Another way would be to place pointers or links periodically in a single contiguous file. This would be a form of linked list. When the basic content was originally written the link and the end of one chunk in the file would point to the start of the next chunk of data. When the file was enhanced the pointer could be rewritten to point to a chunk appended to the end of the file containing the enhanced data. The original basic content would still be left in place and, if the original links were also preserved, this would facilitate undoing the enhancement. An alternative approach might be to leave unused portions of the file periodically during the stream. These could be filled during enhancement without having to rewrite the file. Obviously this latter approach imposes a limit on the amount of extra data that can be added by an enhancement. It should be clear to a man skilled in the art that there are many ways in which the objective of modifying a file in place can be achieved in practice.

These mechanisms could be implemented using the AAF file format or another format designed for storing edited files or for use with editing software.

If enhancements are available before the basic content is received then they could be applied before it is stored to file. This also avoids the need to re-write the file to apply the enhancement.

Drift and Buffer Occupancy

Enhancement of a compressed stream may result in drift. Drift occurs in MPEG systems when the decoded image in the decoder is not the same as that used by the encoder. This could obviously happen if the bit stream were modified by enhancement. For example a typical GOP, in display order, might be B₁, B₂, I₃, B₄, B₅, P₆, B₇, B₈, P₉, B₁₀, B₁₁, P₁₂ (see reference 1). Here I, B or P represents the frame type and the subscript represents the frame number. Such a GOP would be transmitted in a different order to that in which it is displayed to minimise the delays and storage required in the decoder. The example GOP would be transmitted as I₃, B₁, B₂, P₆, B₄, B₅, P₉, B₇, B₈, P₁₂, B₁₀, B₁₁. Frames B₁ and B₂ depend on the last P frame in the preceding GOP (P₀). If the whole GOP is replaced by enhancement then B₁ & B₂ can be coded to take account of unmodified frame P₀, which is known to the enhancement coder, and the enhanced frame I₃. However it is more efficient to enhance only the I frame (leaving motion vectors and mode decisions unchanged) since this requires many fewer bits than the replacing the whole GOP. In this case B₁ & B₂ will be decoded based on the original motion vectors and mode decisions but new transform coefficients from the I frame. Drift would also occur if both I and P frames (collectively referred to as reference frames) were enhanced. In addition to frames B₁ & B₂ being subject to drift frames B₁₃ & B₁₄ (in the next GOP) would also be affected.

Drift errors could just be ignored and the resulting impairments are likely to be minor if the quality of the reference frames is being improved. Indeed the quality of the B frames may actually improve if the quality of the reference frames are improved by enhancement.

The drift caused by enhanced I frames could be eliminated by the use of a modified decoder. Reference frames might be enhanced as part of enhancement of the whole GOP or enhancement of the I and P frames only. The B frames immediately predeceasing an enhanced I frame, or immediately following an enhanced P frame, in presentation order, could be decoded using the original (unpatched) reference frame. B frames following an enhanced I frame or preceding an enhanced P frame could be decoded using the enhanced reference frame. This technique eliminates drift caused by enhancement but at the expense of having to provide a non-standard decoder. Whether this is an appropriate trade off would depend on the application.

Typically streams are coded with open GOPs because this is more efficient. Some B frames in open GOPs are predicted from reference frames in other GOPS (as in the example above). Closed GOPs, by contrast, do not refer to frames outside the GOP when decoding B frames. Closed GOPs could be added to the stream by a “enhancement aware” encoder. The encoder knows when a particularly complex piece content is causing it to do a poor job of encoding. So it could add closed GOPs as “splice points” to avoid problems with drift in an enhanced signal. Closed GOPs do not suffer from the drift problem because, by definition, they do not refer to frames outside the GOP during the decoding process. Hence if reference frames were enhanced in closed GOPs, added as splice points, there would be no problem with drift. The quality of the basic stream would be reduced because closed GOPs are less efficient than open GOPs. The technique would, thus, trade slight degradations in quality of the basic stream for improved quality in the enhanced stream. Again the applicability of this technique would depend on the application.

Enhancement of a compressed stream may result changes in buffer occupancy. Potentially this could create a bit stream that did not comply with the buffer size specified as header information. This may cause problems for some decoders, which may (reasonably) assume the buffer size defined in the stream header is correct. Care must be taken in encoding the enhancement data to avoid this problem. A typical application of enhancement would be to improve the quality of a piece of content. To do this would require more bits than were originally transmitted for the basic content. If the enhanced content were to be transmitted via a constant bit rate channel there would have to be a corresponding change in the bit rate of the channel. If the enhanced stream were then decoded there would probably be a buffer over or underflow unless precautions were taken in encoding the data. These problems, and their solution, are described in prior art UK Patent application 9523042.1 “Flexible Bit Rate Video coding”. One solution to these problems is to have an encoder using the solution in this document to produce the encoded enhancement data. Generally this encoder would have to have a larger coder buffer and more complex rate control algorithms than a coder designed for a constant fixed bit rate.

Changes in buffer occupancy would not cause problems when a variable bit rate channel is used to feed the decoder. This would usually be the case in practice. Common variable bit rate channels might be feeding the decoder direct from hard disk or via an IP (internet protocol) network. In these common scenarios no special precautions would be required at the encoder to prevent buffer over or underflow. The problem does not manifest itself in these scenarios because the decoder can simply use as much, or as little, information as is required to decode each frame.

The problems of drift and buffer occupancy described with reference to the example of MPEG encoding are likely to be common to many compression algorithms. The solutions to these problems will be broadly similar to those described above for the example MPEG compression. The details of the solutions will vary depending on the details of the compression algorithm.

The problems of drift and buffer occupancy do not arise if enhancement is applied after decoding.

Enhancement improves quality by allowing an effectively unlimited coder/decoder buffer size for the content delivered by enhancements. This is possible because the content contained in enhancements does not have to go through a constant bit rate channel and be decoded in real time.

### CONCLUSIONS

The embodiment provides enhancement to programme delivery via multimedia channels. An advantage is the ability to combine content from different sources, delivered via different media, in a unified, efficient and flexible manner. Enhancement is a method of improving the quality of broadcast audio and video after they have been received and stored. It is well suited to an environment of converged broadcast and internet infrastructure in which PVRs are common.

This application discloses a wide range of applications of enhancement and the invention is not limited to any one application or context. Modifications of detail may be provided and each feature disclosed herein may be provided independently or in alternative combinations.

1-45. (canceled)

46. A method of outputting media content, the method comprising
coding the media content according to a predefined coding scheme to produce coded media content, and
supplying enhancement data having information for selectively enhancing at least one portion of the media content.

47. A method of providing media content, the method comprising
receiving media content coded according to a predefined coding scheme,
decoding the media content to produce decoded media content,
receiving enhancement data including information for selectively enhancing at least one portion of the media content, and
providing enhanced decoded media content for said at least one portion based at least in part on the enhancement data.

48. The method of claim 46, wherein the enhancement data and the coded media content are transferred at different times.

49. The method of claim 46, wherein the enhancement data and the coded media content are transferred via different communication media.

50. The method of claim 48, wherein the enhancement data is requested by a receiver subsequent to receipt of the coded media content.

51. The method of claim 48, wherein the enhancement is made available to a receiver prior to scheduled transmission of the coded media content.

52. The method of claim 48, wherein the coded media content is transferred via a broadcast transmission medium.

53. The method of claim 48, wherein at least one of the coded media content and the enhancement data are supplied by a tangible medium.

54. The method of claim 48, wherein the enhancement data is supplied to a receiver over a network.

55. The method of claim 46, wherein the coded media content is compliant with a defined standard format, whereby the coded media content is playable by a decoder compliant with the defined standard in the absence of the enhancement data.

56. The method of claim 46, wherein the enhancement data and the coded media content are supplied substantially simultaneously.

57. The method of claim 56, wherein the enhancement data is generated dynamically as the media content is coded.

58. The method of claim 57, wherein the media content comprises live media content, and wherein outputting of the coded media content is delayed to enable the enhancement data to be output.

59. The method of claim 58, wherein the coded media data is delayed by less than a minute.

60. The method of claim 46, wherein the enhancement data is generated based on user input after the coded media content has been coded.

61. The method of claim 46, wherein the coded media data and the enhancement data are combined in a data stream.

62. The method of claim 47, wherein the received coded media data is stored prior to playback.

63. The method of claim 46, wherein the enhancement data comprises data to be used together with the coded data to be used in decoding the coded data.

64. The method of claim 63, wherein the enhancement data comprises coefficients for use in decoding.

65. The method of claim 47, wherein the enhancement data comprises data to be used together with the decoded data to be used to enhance the decoded data.

66. The method of claim 65, wherein the enhancement data comprises data encoding a difference between the decoded data and the original media content.

67. The method of claim 47, further comprising storing the received media content to enable at least one of outputting of the decoded media content at a user-selected time and repeated playback of the decoded media content.

68. The method of claim 67, wherein the media content is stored in coded form.

69. The method of claim 46, wherein the media content is compressed according to a first coding scheme and the enhancement data is compressed according to a second coding scheme.

70. The method of claim 46, wherein the enhancement data is generated for a portion of media content following a request by a user.

71. The method of claim 46, wherein the coding is performed separately from the supplying of enhancement data.

72. A method of outputting media content, the method comprising
receiving pre-coded media content and source media content, and
deriving enhancement data from the source media content and the coded media content, the enhancement data including information for selectively enhancing a portion of the media content.

73. A method of providing enhancement data for coded media content, the method comprising
providing coded media content coded according to a predetermined coding scheme, and
selectively supplying enhancement data that includes information for selectively enhancing at least one portion of the media content.

74. The method of claim 73, wherein the enhancement data is derived at least in part or the basis of source media content from which the coded media content is derived.

75. The method of claim 73, further comprising identifying an enhancement insertion point based on identifying at least one feature of the coded media content, and storing information identifying the feature and an offset in the data from the feature.

76. A method of identifying at least one of an editing and insertion point for coded media data, the method comprising identifying a feature of the coded media content, and storing information identifying the feature and an offset in the data from the feature.

77. The method of claim 75, wherein the feature is selected to be unique within a given portion of the coded media content.

78. The method of claim 77, wherein the feature is selected to have an estimated probability of repetition within a given portion of the coded media content, the estimated probability being below a selected threshold value.

79. A system for outputting media content, the system comprising
means for coding the media content according to a predefined coding scheme to produce coded media content, and
means for supplying enhancement data having information for selectively enhancing at least one potion of the media content.

80. An enhancement generator for coded media content, the generator comprising
means for receiving coded media content, and
means for supplying enhancement data having information for selectively enhancing at least one portion of the media content.

81. A generator according to claim 80, further comprising means for receiving source media content corresponding to the coded media content.

82. A generator according to claim 80, further comprising a selection input for receiving information selecting at least a portion of the coded media content to enhance.

83. A generator according to claim 82, wherein the selection input is arranged to receive an automatic selection signal.

84. A generator according to claim 82, the generator being arranged to receive user input identifying a portion to enhance, the portion including a user identification of at least one of a frame and a portion of a picture.

85. A generator according to claim 80, further comprising means for storing at least one of the output coded media content and the enhancement data.

86. A generator according to claim 80, further comprising first means for transmitting the coded media data to a user, and second means for transmitting the enhancement data to a user, wherein at least one of the first and second means for transmitting includes one of a broadcast transmission channel, means for recording data onto a tangible medium, and a network interface.

87. A receiver comprising
means for receiving media content coded according to a predefined coding scheme,
means for decoding the media content to produce decoded media content,
means for receiving enhancement data having information for selecting enhancing at least one portion of the media content, and
means for providing enhanced decoded media content for said at least portion based at least in part on the enhancement data.

88. A receiver according to claim 87 further comprising means for storing the media content.

89. A receiver according to claim 87, the receiver having a first input for receiving the media content and a second input for receiving the enhancement data.

90. A computer readable medium having encoded thereon software for outputting media content, the software including instructions for
coding the media content according to a predefined coding scheme to produce coded media content, and
supplying enhancement data having information for selectively enhancing at least one portion of the media content.
